(19) United States
(12) Patent Application Publication
(10) Pub. No.: US 2004/0179671 A1
(43) Pub. Date: Sep. 16, 2004

(54) Exchange

(75) Inventors: Ryouta Nonaka, Oonojyou-shi (JP); Hitoshi Fukuda, Fukuoka-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/799,709

(22) Filed: Mar. 15, 2004

(30) Foreign Application Priority Data
Mar. 14, 2003 (JP) 2003-069997
Feb. 6, 2004 (JP) 2004-030341

(51) Int. Cl. H04M 3/00; H04M 5/00

(52) U.S. Cl. 379/265.02

(57) ABSTRACT

It is an objective of the present invention to provide an exchange capable of answering an incoming call on a higher priority even in a state where the incoming traffic to an extension group is so high that incoming calls are placed on hold without being answered.

The exchange comprises a controller, once the extension stations are now ready for answering calls, which references the queuing table 15d to determine that two or more extension groups have calls waiting to be answered, and determines the extension group whose calls to be answered are to terminate to an extension station 2, in accordance with the priority of the extension group to which the call to be answered belongs.

### BACKGROUND OF THE INVENTION

1. Field of the Invention

The present invention relates to a telephone exchange such as a private branch exchange (PBX) capable of terminating calls to an extension group.

2. Description of the related art

Telephone exchanges have been available which can group a plurality of extension stations and simultaneously terminate a call to the extension stations in the group (for example, refer to the Japanese Patent Laid-Open No. 134953/1990).

According to the aforementioned related art exchange, incoming calls terminate to an extension group in the order of the incoming calls without exception. A call originated by an important customer may be left unanswered when traffic of incoming calls to the extension group is high and the customer may hang up before the call is answered. This could offend the caller, resulting in a loss of a business chance.

### SUMMARY OF THE INVENTION

In view of the related art problem, the present invention aims at providing an exchange capable of answering an incoming call from an important customer on a higher priority even in a state where the incoming traffic to an extension group is so high that incoming calls are placed on hold without being answered.

In order to solve the problems, the invention provides an exchange to which extension stations can be connected, the exchange comprises a call termination waiting table which stores calls to an extension station which belongs to an extension group per extension group number and control means for storing, as a call to be answered, a call left unconnected to any of the extension stations in an extension group in the call termination waiting table, and which, once the extension stations are now ready for answering calls, references the call termination waiting table to determine that two or more extension groups have calls waiting to be answered, and determines the extension group whose calls to be answered are to terminate to an extension station, in accordance with the priority of the extension group to which said call to be answered belongs.

This provides an exchange capable of answering an incoming call from an important customer on a higher priority even in a state where the incoming traffic to an extension group is so high that incoming calls are placed on hold without being answered.

### BRIEF DESCRIPTION OF THE DRAWINGS

FIG. 1 is a block diagram of an exchange according to Embodiment 1 of the invention;

FIG. 2 is an internal block diagram of an extension station according to Embodiment 1 of the invention;

FIG. 3 is an external view of the extension station according to Embodiment 1 of the invention;

FIG. 4 is a table showing incoming call destinations according to Embodiment 1 of the invention;

FIG. 5 shows a group termination table according to Embodiment 1 of the invention;

FIG. 6 shows a VIP-G setting table according to Embodiment 1 of the invention;

FIG. 7 shows a queuing table according to Embodiment 1 of the invention;

FIG. 8 shows a function key table according to Embodiment 1 of the invention;

FIG. 9 is a first flowchart showing the processing assumed in case a plurality of incoming calls attempt to terminate to an extension group of an exchange according to Embodiment 1; and

FIG. 10 is a second flowchart showing the processing assumed in case a plurality of incoming calls attempt to terminate to an extension group of an exchange according to Embodiment 1.

### DESCRIPTION OF THE PREFERRED EMBODIMENTS

Embodiments of the invention are described below referring to drawings.

(Embodiment 1)

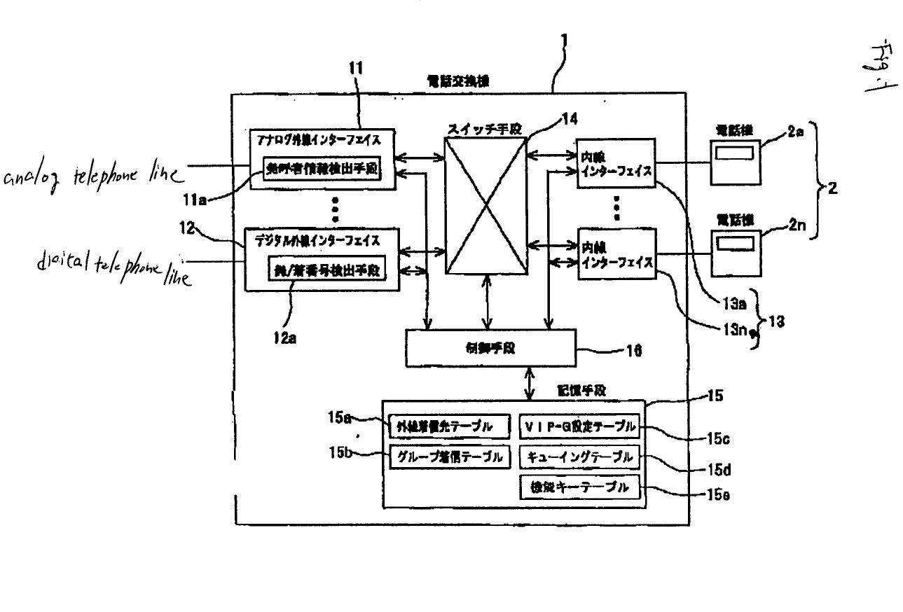

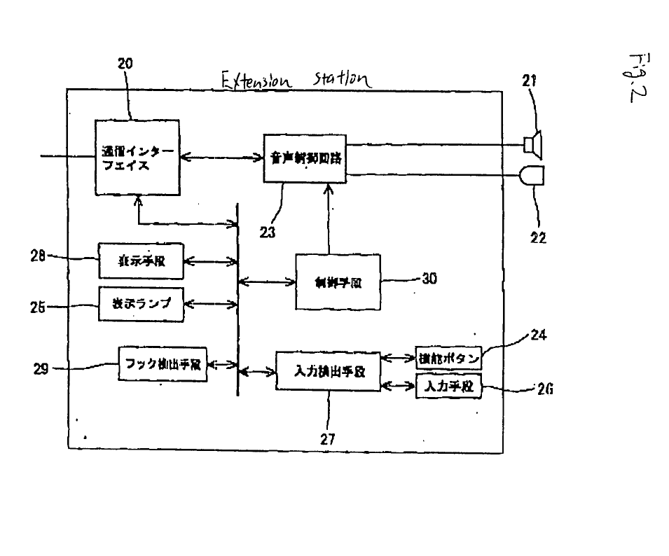

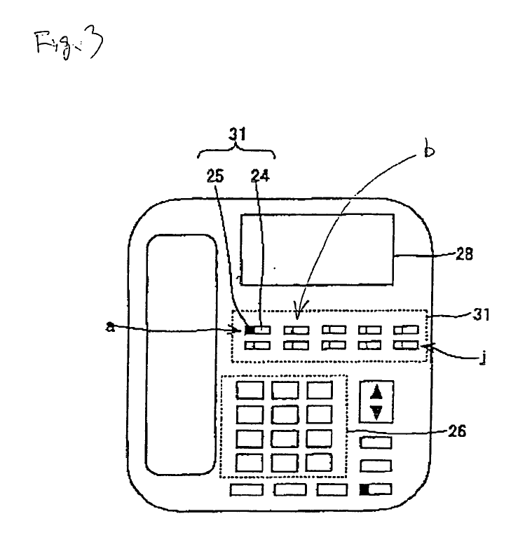

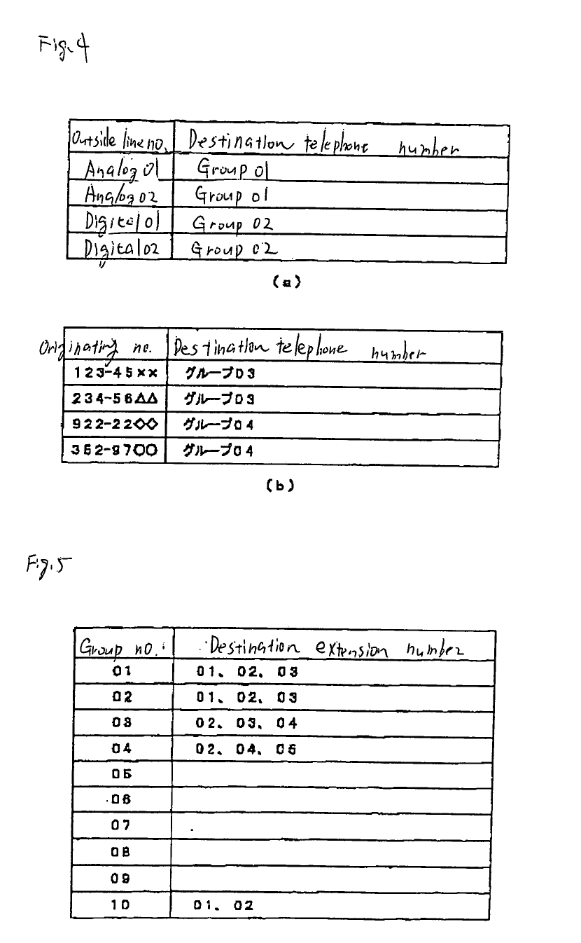

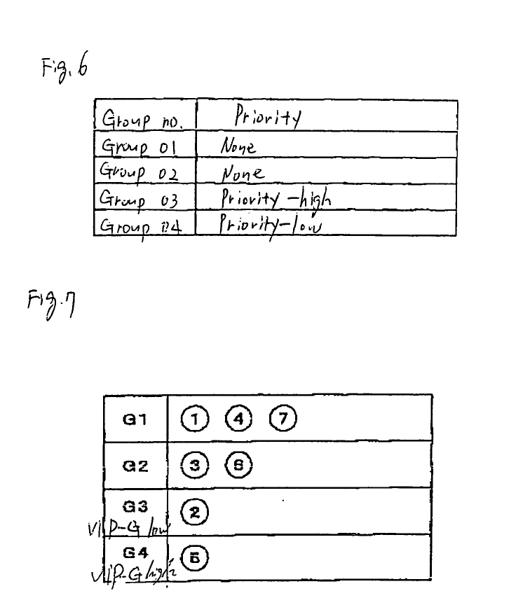

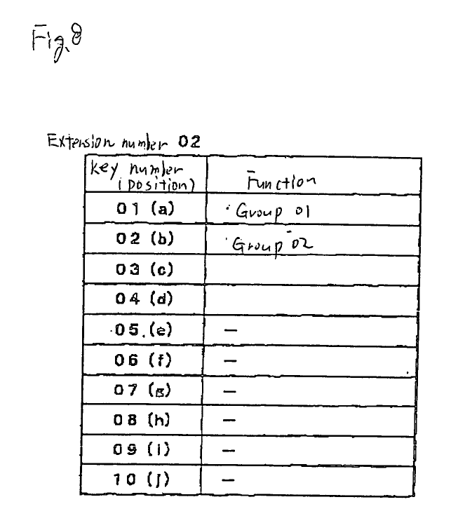

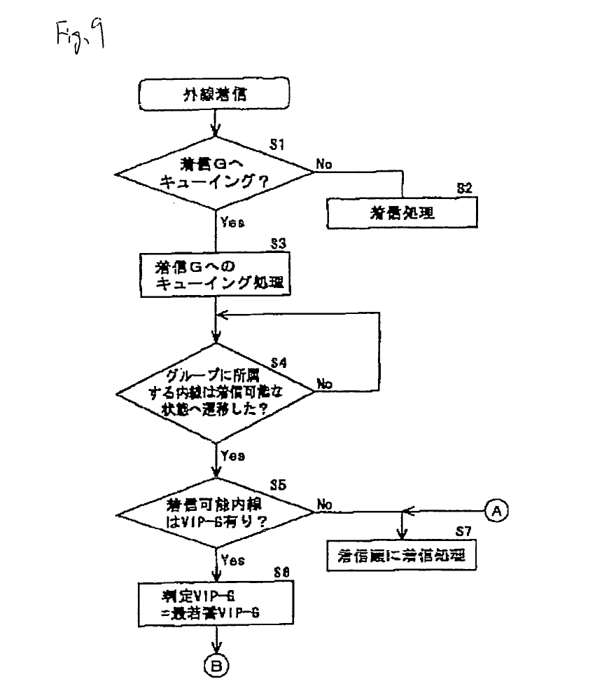

FIG. 1 is a block diagram of an exchange according to Embodiment 1 of the invention. FIG. 2 is an internal block diagram of an extension station 2 according to Embodiment 1 of the invention. FIG. 3 is an external view of the extension station according to Embodiment 1 of the invention. FIG. 4 is a table showing incoming call destinations according to Embodiment 1 of the invention. FIG. 5 shows a group termination table according to Embodiment 1 of the invention. FIG. 6 shows a VIP-G setting table according to Embodiment 1 of the invention. FIG. 7 shows a queuing table according to Embodiment 1 of the invention. FIG. 8 shows a function key table according to Embodiment 1 of the invention.

Referring to FIG. 1, a numeral 1 represents an exchange such as a PBX, and 2, 2a, . . . , 2n telephone sets such as extension stations connected to the exchange 1. The extension station 2 is a general name of the extension stations 2a, . . . , 2n.

A numeral 11 represents an analog outside line interface for connecting to and communicating with an analog telephone line, 12 a digital outside line interface for connecting to and communicating with a digital telephone line, 11a caller information detection means, 12a originating/terminating number detection means, 13, 13a, . . . , 13n extension interfaces for connecting an extension station, 14 switch means for connecting and disconnecting a sound signal transmitted between the analog outside line interface 11, digital outside line interface 12 and extension interface 13. The extension interface 13 is a general name of the extension interfaces 13a, . . . , 13n. The caller information detection means 11a is provided on the analog outside line interface 11 while the originating/terminating number detection means 12a is provided on the digital outside line interface 12.

A numeral 15 represents storage means for storing a program and various setting information and includes an incoming call destination table 15a, a group termination table 15b, a VIP-G setting table 15c, and a queuing table 15d (a call termination waiting table of the invention).

The incoming call destination table 15a maps the destinations of calls terminating to the analog outside line interface 11 and the digital outside line interface 12 to the caller information received on the outside line interfaces 11, 12 and the caller information detection means 11a, in order to determine the appropriate destinations.

In particular, as shown in FIGS. 4A and 4B, the incoming call destination table 15a includes an incoming call destination table A in FIG. 4A which maps destination telephone numbers to the outside line interfaces 11, 12 and an incoming call destination table B in FIG. 4B which maps destination telephone numbers to the originating numbers.

For example, the incoming call destination table A in FIG. 4A assigns destinations (an extension group having a group number 01 for analog 01 and analog 02, an extension group having a group number 02 for digital 01 and digital 02) to two analog outside line interfaces 11 (analog 01, analog 02) and two digital outside line interfaces 12 (digital 01, digital 02). For example, in case a call terminates to the digital outside line interface 12 having the outside line number digital 02, the incoming call destination table A is referenced and the extension group of group 02 is fetched and the call terminates to the extension station 2 which belongs to the extension group 02. In the incoming call destination table B of FIG. 4B, the extension group having the group number 03 is mapped to an originating number “123-45XX” while the extension group having the group number 04 is mapped to an originating number “922-22⋄⋄”. Thus, in case the originating number “123-45XX” is received by the caller information detection means 11a or the originating/terminating number detection means 12a, the incoming call destination table B is referenced and the extension group having a group number 03 corresponding to the originating number “123-45XX” is fetched and the call terminates to the extension station 2 which belongs to the extension group corresponding to the group number 03.

In case the caller information detection means 11a or originating/terminating number detection means 12a has received an originating number, the incoming call destination table B is referenced on a higher priority. In case no destination telephone numbers corresponding to the incoming call destination table B are found, the incoming call destination table A is referenced next in order to determine an extension station to which the call is to terminate.

While only extension groups are assigned as incoming call destinations in FIGS. A and B for simplicity, it is also possible to assign the extension numbers of extension stations.

The group termination table 15b is used to simultaneously terminate an incoming call from a telephone line to a plurality of extension stations 2. The table can map at least two extension numbers to an extension group number. The group termination table 15b can be set on a computer (not shown) connected to the extension station 2 or exchange 1. As shown in FIG. 5, the group termination table 15b can set two or more extension numbers assigned per extension interface 13 to each group number (extension group number). For example, in FIG. 5, extension numbers 01, 02, 03 are mapped to the extension group having the group number 01 while extension numbers 02, 03, 04 are mapped to the extension group having the group number 03.

The VIP-G setting table 15c is a table where priorities of calls waiting to be answered in each group number of an extension group is set. For example, in case the VIP-G setting table 15c is set as shown in FIG. 6, the extension groups having the group numbers 01, 02 have no priorities, the extension group having the group number 03 has a higher priority, and the extension group having the group number 04 has a lower priority. The VIP-G setting table 15c can be set on a computer (not shown) connected to the extension station 2 or exchange 1.

The queuing table 15d (call termination waiting table according to Embodiment 1 of the invention) stores, in case there is an incoming call left unanswered by any of the extension stations in man extension group, as a call waiting to be answered by the target extension group, in relation to the extension group number.

For example, assume that the queuing table 15d is as shown in FIG. 7. Encircled portions mean calls waiting to be answered. Encircled numerals 1 through 7 the order these calls terminated to the outside line interfaces 11, 12 of the exchange 1. Numerals G1 through G4 mean the group numbers of an extension group. Assume that, in the VIP-G setting table, the extension group having the group number 03 is set to “Priority-low” while the extension group having the group number 04 is set to “Priority-high”. The priority “Priority-high” has the highest priority among the high-priority groups. The priority “Priority-low” has the second-highest priority among the high-priority groups.

In the state of FIG. 7, in case the extension stations which belong to all extension groups G1 through G4 (for example extension stations having the extension number 02 in FIG. 5) are ready to answer an incoming call, the call waiting to be answered 5 (call waiting to be answered which is to terminate to an extension group with a higher priority) first terminates to an extension station. After that, control means 16 performs call termination control in the order of the calls waiting to be answered 2, 1, 3, 4, and so on.

A function key table 15e maps function buttons 31 with indication function comprising a combination of function buttons 24 and indicators 25 in FIG. 3 mentioned later to functions to be executed.

The function key table 15e can be assigned to each extension number of the extension station 2. For example, assuming that the function key table 15e is set as shown in FIG. 8, the function button 31 with indication function in a position a corresponds to the group 01 as an extension group number. When an incoming call terminates to the extension group number 01, the control means 16 causes the indicator 25 to blink or illuminate in order to notify an incoming call to the extension group of the group number 01. The user of the extension station 2 presses the function button 24 to answer an incoming call to the extension group of the group number 01.

The numeral 16 represents control means for controlling the entire exchange 1 as well as performing various control such as outside line control, extension control and call control.

FIG. 2 shows an internal block diagram of an extension station 2. In FIG. 2, a numeral 20 represents a communications interface for connecting to the extension interface 13 of the exchange 1, 21 voice output means such as a loudspeaker for outputting a sound signal from the exchange 1, 22 a microphone for inputting voice, 23 a voice control circuit for performing voice processing in order to appropriately output the sound signal output from the exchange 1 to the loudspeaker 21 and in order to appropriately outputting a sound signal input from the microphone 22 to the exchange 1 via the communications interface 20.

A numeral 24 represents the aforementioned function buttons for outputting pressing information to the exchange 1, 25 indicators for giving indication related to the function buttons. The indicator 25 is not limited to an LED but may be any indication means such as an LCD as long as it can indicate information related to the function button 24.

A numeral 26 represents input means such as a ten-key pad used to input a telephone number, 27 input detection means for detecting an input such as a press on the function button 24 and the input means 26. The input means 26 detects any input on the function button 24 and the input means 26 and notifies control means 30 mentioned later of detection of input. The control means 30 notifies the exchange 1 of the detection information via the communications interface 20.

A numeral 28 represents display means which displays information received by the extension station 2 from the exchange 1. In particular, receiving the display information transmitted from the control means 16 of the exchange, the control means 30 causes the display means 28 to display on the display means 28 the content which is based on the received display information.

A numeral 29 represents hook detection means for detecting the state of a switchhook (not shown) and whether a handset (not shown) is lifted from the cradle of a telephone set. A numeral 30 represents control means for controlling the entire extension station 2.

FIG. 3 is an external view of the extension station 2 according to Embodiment 1 of the invention. The function buttons 31 with indication function are arranged above the ten-key pad 25 including a plurality of keys in the positions a through j as shown in FIG. 3. As mentioned above, the function buttons 31 with indication function comprise function buttons 24 and indicators 25. As shown in FIG. 3, these are arranged adjacent to each other. This allows the user to readily understand the correspondence between the buttons and the display means. The function buttons 31 with indication function maybe integrated from the function buttons 24 and the indicators 25.

The function key table 15e maps the function buttons 31 with indication function comprising function buttons 24 and indicators 25 shown in FIG. 3 to the functions to be executed.

Assume that the function key table 15e is assigned to each extension number of the extension station 2. For example, assuming that the function key table 15e is set as shown in FIG. 8, the function button 31 with indication function in a position a in FIG. 3 (hereinafter referred to as the function button 31a with indication function) is a key corresponding to the extension group number 01. When a call terminates to the extension group 01, the control means 16 causes the indicator 25 to blink or illuminate in order to notify an incoming call to the extension group of the group number 01. The user of the extension station 2 presses the function button 24 to answer an incoming call to the extension group of the group number 01. The function button 31 with indication function in a position b in FIG. 3 (hereinafter referred to as the function button 31b with indication function) is a key corresponding to the extension group number 02. Same as the operation of the function button 31a with indication function in the position a, the key can be used to notify and answer an incoming call to the extension group of the group number 02.

In case, as shown in FIG. 6, four incoming call group keys including the groups 01, 02, 03 and 04 are set to the extension station having the extension number 02, incoming calls terminate to more than one extension group, for example, to the extension group 01 first, then the extension group 02, the control means 16 terminates the incoming call to the extension groups to the extension station 2 in the extension group 02. The control means 16 registers an incoming call to the extension group 02 to G2 (extension group 02) in the queuing table 15d. The user of the extension station in the extension group 02 lifts the handset (goes off-hook) to answer the incoming call to the extension group 01, thereby allowing conversation with the distant party of the incoming call. Even before the user goes off-hook, the extension group key of the extension group 02 is set to the extension station having the extension number 02. The indicator 25b of the function button 31b with indication function blinks or illuminates. The control means 16 thus notifies the presence of an incoming call waiting to be answered to the extension group number 02. When the user presses the function button 24b, he/she can answer an incoming call to the extension group 02 on a higher priority than an incoming call to the extension group 01. In this practice, the incoming call to the extension group 01 is registered to G1 (extension group 01) in the queuing table 15d.

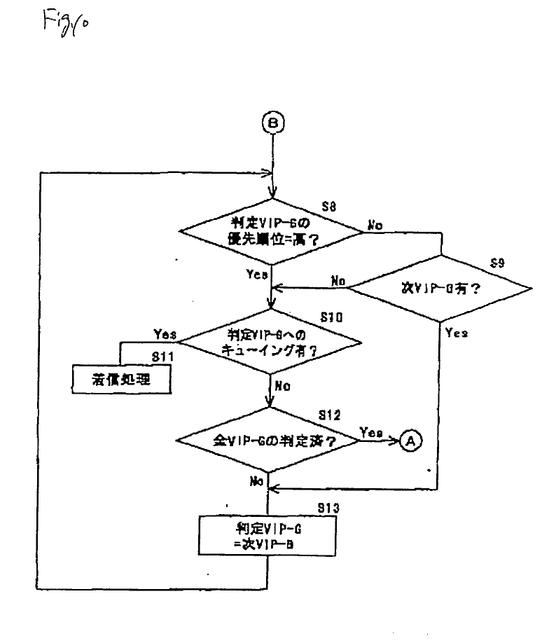

Operation of the exchange 1 thus configured is described below referring to FIGS. 9 and 10.

Operation assumed when a plurality of incoming calls terminate to extension groups will be described.

On an incoming call from the telephone line to the analog outside line interface 11 or digital outside line interface 12, the control means 16 determines whether the originating number and the terminating number have been communicated depending on whether such information is received on the caller information detection means 11a and the originating/terminating number detection means 12a. In case the control means 16 has determined that the originating number and the terminating number have been communicated, the control means 16 references the incoming call destination table B to fetch the extension number and extension group number of the target extension station. In case the control means 16 has determined that the originating number and the terminating number have not been communicated, the control means 16 references the incoming call destination table A to fetch a target extension group number, then determines whether the call can terminate to the extension group of the fetched extension group number. Whether the call can terminate to the extension group is determined based on whether all of the extension stations which belong to the extension group are in use or busy and cannot answer the call (S1). In case no more than one extension station can be used to answer the call even when any of the extension stations which belong to the extension group is in standby state (ready to answer the call) in order to secure at least one extension station from which calls can be originated, a determination may be made not to terminate the incoming call to the extension group. Other various conditions may be used as criteria for determination.

In case it is determined that the call can terminate to the destination extension group in S1 (in case it is determined that the call should not be queued in the queuing table 15d), processing (termination processing) such as call termination notice (output of a ringing signal) is made on extension stations which belong to the destination extension group (S2). In case it is determined that the call cannot terminate to the destination extension group in S1 (in case it is determined that the call should be queued in the queuing table 15d), the call is set (queued) as a call waiting to be answered in the predetermined area of the queuing table 15d corresponding to the group number of the extension group (S3).

Next, it is determined whether a transition is made to a state where any of the extension stations which belong to the extension group is ready to take the call (standby state) (S4). In case a transition is made to a state where any of the extension stations which belong to the extension group is ready to take the call, it is determined whether the extension station which belongs to the extension group belongs to a plurality of extension groups, based on the group termination table 15b. In case the extension station 2 belongs to a plurality of extension groups, priority of the extension group which accommodates the extension station 2 is determined based on the VIP-G setting table 15c (S5). In case an extension group where “VIP-G (priority)” is set is not found, the call waiting to be answered first registered to the queuing table 15d (call terminating to the extension group of the exchange 1) is fetched and termination processing such as call termination notice (output of a ringing signal) is performed (S7).

In case an extension group where “VIP-G (priority)” is set is found, an extension group having the smallest number is selected as an extension group for determining termination processing (S6).

Next, it is determined whether the extension group selected for determination is set to “VIP-G-High” (S8). In case the extension group is set to“VIP-G-High”, it is determined whether a call waiting to be answered is registered to the extension group (presence/absence of queuing) (S10). In case a call waiting to be answered is registered to the extension group, the call waiting to be answered in the selected extension group is dequeued from the queuing table 15d, follows by termination processing such as call termination notice (output of a ringing signal) (S11). In case a plurality of calls waiting to be answered are present for the extension group selected for determination, the first registered call is dequeued.

It is then determined whether any call waiting to be answered is present for all extension groups where “VIP-G (priority)” is set (S12). In case determination is not yet made for all extension groups, the extension group having the smallest group number among the extension groups where “VIP-G (priority)” is set which have not been determined, is selected as an extension group for determination (S13).

In case it is determined that the selected extension group is not set to “VIP-G-High”, it is determined whether there is another extension group where “VIP-G (priority)” is set (S9) In case such an extension group is found, the extension group is selected for determination (S13), followed by steps S8, and S10 through 12.

The control means 16, when assuming that the number of calls waiting to be answered exceeds a predetermined count (“number of calls waiting to be answered for call forwarding”, for example 4), causes to blink the indicator 24 of the function button 31 with indication function as an extension button of the extension station 2 which belongs to the extension group in order to notify that the number of calls waiting to be answered exceeds a predetermined count. The indicator 24 continues to blink as long as the number of calls is equal to or more than the predetermined count. When the number is equal to or less than the predetermined count, blinking ends. For example, in case the number of calls waiting to be answered for call forwarding is 3 for the extension group having the group number 2, when the number of calls waiting to be answered in the extension group having the group number 2 exceeds 3, the control means 16 causes to blink the indicator 24 of the function button 31 with indication function as an extension button of the extension station 2 which belongs to the extension group of the group number 2. The number of calls waiting to be answered for call forwarding used by the control means 16 for determination can be set on an extension station or a computer connected to the exchange 1. The corresponding information is stored into storage means. As well as use of the indicator 24, the control means 16 may control the voice control circuit 23 of the extension station 2 to cause the loudspeaker 21 to output a warning tone. This notifies the extension stations in the group of that fact that the number of calls waiting to be answered in the extension group exceeds a predetermined count. The users of the extension stations in the group, understanding the situation, intentionally speed up the ongoing calls and process without delay the incoming calls waiting to be answered. This reduces the discomfort of a caller attempting to reach the extension group.

The control means 16, assuming that the number of calls waiting to be answered exceeds a predetermined count (herein after referred to as the number of overflow calls waiting to be answered, for example 5) for an extension group, terminates the calls waiting to be answered to other destinations. It is possible to previously register the destinations as an overflow call forwarding table (not shown) in the storage means 15 and terminate calls in excess of a predetermined number (for example those exceeding 5 calls) to other destinations in accordance with this table.

Assume that the number of overflow calls waiting to be answered is 5 for the extension group of the group number 2 and the extension group of the group number 05 is set as an overflow call forwarding destination. When the number of calls waiting to be answered exceeds 5 for the extension group of the group number 2, the calls waiting to be answered after the fifth call in the order of termination are forwarded to the extension group of the group number 05 to terminate to the same extension group. In case the number of the calls waiting to be answered which have been forwarded exceeds the count of overflow calls waiting to be answered of the extension group of the group number 05, the calls in excess are forwarded to the overflow destination of the extension group of the group number 05.

The predetermined number of calls waiting to be answered which is used by the control means for determination can be set on the extension station 2 or a computer connected to the exchange 1. The corresponding information is stored into storage means.

Thus, even in case an extension group has calls waiting to be answered beyond the processing ability of the users of the extension stations in the extension group, the calls in excess can be terminated to the extension stations which belong to another destination extension group or an extension group having an extension number. This reduces the discomfort of a caller attempting to reach the extension group.

The control means 16 fetches the number of calls waiting to be answered, longest waiting time among the call waiting to be answered and extension group numbers from the queuing table 15d and displays the data on the display means of the extension station 2. In this case, by way of predetermined operation on an extension station or a computer connected to the exchange 1, the control means 16 registers whether to set the state of the calls waiting to be answered for which extension group will be displayed (state display of a plurality of extension groups available) to a queuing table (not shown) per extension station 2. The control means 16 displays the content of the queuing table on the display means of the extension station 2 in accordance with the registration. In this way, the extension stations in an extension group are notified of how many calls are waiting to be answered in the group. Users of the extension stations in the group understand the situation and intentionally speed up the ongoing calls and process without delay the incoming calls waiting to be answered. This reduces the discomfort of a caller attempting to reach the extension group.

As mentioned hereinabove, according to Embodiment 1, in case an extension station belongs to a plurality of extension groups, an incoming call to the extension station from an important customer may be terminated to the same extension station on a higher priority than other calls waiting to be answered. It is thus possible to terminate a call from an important customer to an extension station on a higher priority even when the extension group has lower-priority calls waiting to be answered.

According to an exchange of the invention, a call which is left unanswered by any of the extension stations which belong to an extension group is stored as a call waiting to be answered into a call termination waiting table, and once termination is allowed, based on a determination that calls are waiting to be answered in more than one extension group to which the extension station belongs in the call termination waiting table, it is determined which extension group is given priority in answering their calls waiting to be answered on the extension stations accommodated, in accordance with the priorities of the extension groups to which the calls waiting to be answered belong. In case an extension station belongs to a plurality of extension groups, an incoming call to the extension station from an important customer may be terminated to the same extension station on a higher priority than other calls waiting to be answered. It is thus possible to terminate a call from an important customer to an extension station on a higher priority even when the extension group has lower-priority calls waiting to be answered.

In case extension stations belong to a plurality of extension groups, a call from an important customer is terminated to a target extension group on a higher priority than other calls waiting to be answered. Thus it is possible to terminate an incoming call from an important customer to an extension station even when the accommodating extension group has other calls waiting to be answered.

The extension station is notified that the number of calls waiting to be answered for the extension group exceeds a predetermined count (the first count). Users of the extension stations in the group understand the situation and intentionally speed up the ongoing calls and process without delay the incoming calls waiting to be answered. This reduces the discomfort of a caller attempting to reach the extension group.

Even in case the number of calls waiting to be answered in a extension group exceeds the limit of handing by the users of the extension stations in the group, that is, the second count, the call can terminate the an extension station in the extension group of another destination or an extension station having a separate extension number. This reduces the discomfort of a caller attempting to reach the extension group.

The extension stations in a group how many calls are waiting to be answered by an extension group and how long they are left unanswered. Thus the users of the extension stations in the group understand the situation and intentionally speed up the ongoing calls and process without delay the incoming calls waiting to be answered. This reduces the discomfort of a caller attempting to reach the extension group.

The incoming calls are answered in the order they terminated to extension groups unless the groups are set to priority call termination. Thus it is possible to answer incoming calls on an extension station in the order they terminated. This reduces the discomfort of a caller attempting to reach the extension group.

What is claimed is:

1. An exchange to which extension stations can be connected, comprising:
a call termination waiting table, which stores calls to an extension station which belongs to an extension group per extension group number; and
a controller, which stores a call left unconnected to any of the extension stations in an extension group in the call termination waiting table as a call to be answered, and references the call termination waiting table once the extension stations are now ready for answering calls, and, in case that two or more extension groups accommodating the extension stations have calls waiting to be answered in the call termination waiting table, determines the extension group whose calls to be answered are to terminate to an extension station, in accordance with the priority of the extension group to which the call to be answered belongs.

2. The exchange according to claim 1, wherein in case that the controller determines that the number of calls waiting to be answered in an extension group exceeds a first count, the controller notifies the extension stations which belong to the extension group that the number of calls waiting to be answered exceeds the first count.

3. The exchange according to claim 1, wherein in case that the controller determines that the number of calls waiting to be answered in an extension group exceeds a second count, the controller terminates a call waiting to be answered to another destination.

4. The exchange according to claim 1, wherein the controller fetches, from a call termination waiting table, at least the number of calls waiting to be answered and the longest waiting time among the calls waiting to be answered and displays the data on a display of the extension station.

5. The exchange according to claim 1, wherein the controller, once the extension stations are now ready for answering calls, references the call termination waiting table, and in case that two or more extension groups accommodating the extension stations have calls waiting to be answered in the call termination waiting table, the controller terminates calls waiting to be answered in the order they terminated unless any of the extension groups accommodating the calls waiting to be answered is set to priority call termination.
